(19) United States
(12) Patent Application Publication
(10) Pub. No.: US 2026/0099231 A1
(43) Pub. Date: Apr. 9, 2026

(54) MULTI-SENSE CONTROL BUTTON AND PROCESSING

(71) Applicant: Cypress Semiconductor Corporation, San Jose, CA (US)

(72) Inventors: Igor KRAVETS, Lviv (UA); Oleksandr HOSHTANAR, Lviv (UA); Andriy MAHARYTA, Lviv (UA); Oleksandr KARPIN, Lviv (UA); Vibheesh BHARATHAN, Pleasanton, CA (US)

(73) Assignee: Cypress Semiconductor Corporation, San Jose, CA (US)

(21) Appl. No.: 19/187,838

(22) Filed: Apr. 23, 2025

Related U.S. Application Data
(60) Provisional application No. 63/703,616, filed on Oct. 4, 2024.

(51) Int. Cl. G06F 3/044; G06F 3/041; G06F 3/043

(52) U.S. Cl. CPC G06F 3/0447; G06F 3/04144; G06F 3/04164; G06F 3/0436

(57) ABSTRACT

In an embodiment of the techniques presented herein, a control button comprises a body, a touch sensor proximate a first surface of the body, a force sensor, and a multi-sense controller connected to the touch sensor and the force sensor and configured to identify a touch event based on an analog response of the touch sensor and identify a force event based on an analog response of the force sensor.

### CROSS REFERENCE TO RELATED APPLICATION(S)

This application claims the benefit of and priority to U.S. Provisional Application Ser. No. 63/703,616, entitled “MULTI-SENSE CONTROL BUTTON AND PROCESSING” and filed on Oct. 4, 2024, which is expressly incorporated by reference herein in its entirety.

### BACKGROUND

Computing devices have user interface devices, control buttons, touch-sensor sliders, touch-sensor buttons, etc. Capacitance-sensing devices are, at times, used to replace mechanical buttons, knobs, and other similar mechanical user interface controls in user interface devices. Capacitance-sensing devices have relatively few complicated mechanical parts, springs, etc., and can generally provide reliable operation under harsh conditions. In addition, capacitance-sensing devices are widely used in modern customer applications, allowing new user interface options to be developed relatively easily in existing products.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a control button comprises a body, a touch sensor proximate a first surface of the body, a force sensor, and a multi-sense controller connected to the touch sensor and the force sensor and configured to identify a touch event based on an analog response of the touch sensor and identify a force event based on an analog response of the force sensor.

In an embodiment of the techniques presented herein, a multi-sense controller comprises a sensor interface and a processor configured to receive analog touch data over the sensor interface, identify a touch event based on the touch data, receive analog force data over the sensor interface, identify a force event based on the force data, and communicate the touch event and the force event to a device.

In an embodiment of the techniques presented herein, a method comprises receiving analog touch data over a sensor interface, identifying a touch event based on the touch data, receiving analog force data over the sensor interface, identifying a force event based on the force data, and communicating the touch event and the force event to a device.

In an embodiment of the techniques presented herein, a system comprises means for receiving analog touch data over a sensor interface, means for identifying a touch event based on the touch data, means for receiving analog force data over the sensor interface, means for identifying a force event based on the force data, and means for communicating the touch event and the force event to a device.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIGS. 1A and 1B are views of a control button, in accordance with some embodiments.

FIGS. 2A and 2B are views of a control button, in accordance with some embodiments.

FIGS. 3A and 3B are views of a control button, in accordance with some embodiments.

FIGS. 4A and 4B are views of a control button, in accordance with some embodiments.

FIGS. 5A and 5B are views of a control button, in accordance with some embodiments.

FIGS. 6A and 6B are views of a control button, in accordance with some embodiments.

FIGS. 7A and 7B are views control buttons, in accordance with some embodiments.

FIGS. 8A and 8B are views control buttons, in accordance with some embodiments.

FIGS. 9A and 9B are views control buttons, in accordance with some embodiments.

FIG. 10 is a diagram of a multi-sense controller, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

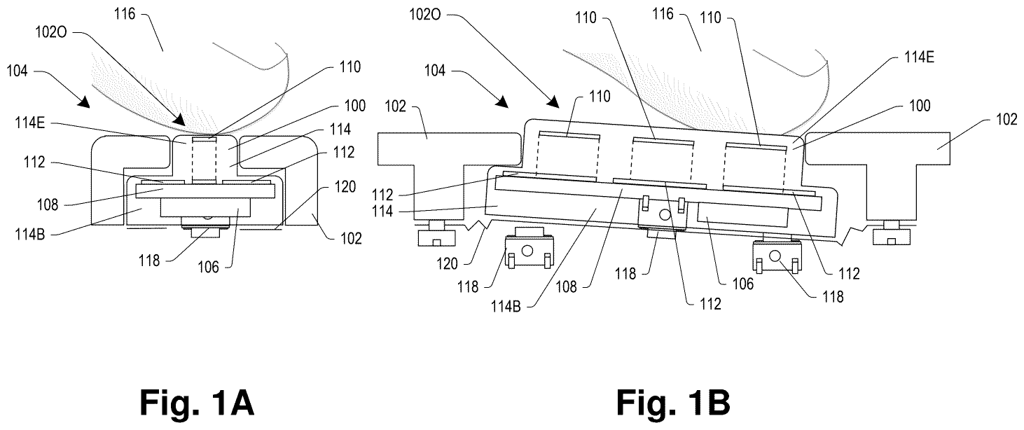

FIGS. 1A and 1B are diagrams of a control button 100 supported within a casing 102 of a device 104, in accordance with some embodiments. FIG. 1A illustrates a view along a width direction of the control button 100 and FIG. 1B illustrates a view along a length direction of the control button 100. In some embodiments, the control button 100 comprises a multi-sense controller 106 mounted to a printed circuit board 108 and connected to at least one touch sensor 110 and at least one force sensor 112. In the embodiment of FIGS. 1A and 1B, the printed circuit board 108 and multi-sense controller 106 are mounted horizontally (e.g., parallel to the upper surface of the control button 100). The number of touch sensors 110 and force sensors 112 may vary. In some embodiments, the control button 100 includes a body 114 that may comprise a molded material that encapsulates the multi-sense controller 106, the touch sensors 110, and the force sensors 112. In some embodiments, the touch sensors 110 comprise capacitive sensors that allow identification of touch events from a user's finger 116 by the multi-sense controller 106 based on a response of the touch sensors 110, such as single taps, double taps, finger slides, or other touch events. In some embodiments, one or more mechanical switches 118 may be provided proximate the control button 100 to generate a digital displacement indication of the control button 100 being pressed downward. The output of the mechanical switch 118 may be registered by the device 104 rather than the multi-sense controller 106. In some embodiments, one or more springs 120, such as a leaf spring, a coil spring, a cantilevered spring, a spring contact, or some other type of spring is provided under the control button 100 to provide resistance to the force applied to the control button 100 by the user's finger 116.

Portions of the force sensors 112 may extend beneath the casing 102 and allow measure displacement relative to the casing 102 representative of force applied to the control button 100 from the user's finger 116. The force sensors 112 may be capacitive sensors or inductive sensors that generate analog signals indicative of displacement of the control button 100 relative to the casing 102 based on a force applied by the user's finger 116. The relative displacement between the force sensor 112 and the casing 102 causes a change in the capacitance or inductance characteristics of the force sensor 112 that is read by the multi-sense controller 106 to identify force events based on force metrics, such as a magnitude and a direction of the force or displacement. The type of force event associated with displacement of the control button 100 may be determined based on the direction of the force or displacement measured based on responses of the force sensors 112. For example, if the force metrics measured by both force sensors 112 have the same direction, a downward force event (i.e., a click event) for the control button 100 is indicated. However, if force metrics measured by both force sensors 112 have different directions, a tilt event of the control button 100 is indicated. As seen in FIG. 1B, the touch sensors 110 may be positioned along an upper surface of the extending portion 114E of the control button 100 to allow detection of different touch events, such as a left side touch event, a middle side touch event, a right side touch event, a left-to-right finger slide event, or a right-to-left finger slide event. In some embodiments, the force event comprises a displacement measurement generated based on the response of the force sensor 112.

The multi-sense controller 106 may communicate touch events detected using the touch sensors 110 or force events detected using the force sensors 112 to the device 104 to generate user interface inputs that may be processed by the device 104. The action taken by the device 104 may depend on the type of touch event or force event detected. For example, different actions may be associated with a single tap touch event, a double tap touch event, or a finger slide registered by the touch sensors 110 or associated with a single click, a double click, a persistent press, or a tilt event registered by the force sensors 112. In an embodiment where the force event is a displacement measurement, the device 104 may identify a click event based on the distance and identify a persistent press if the displacement remains within a predetermined range for a predetermined time interval.

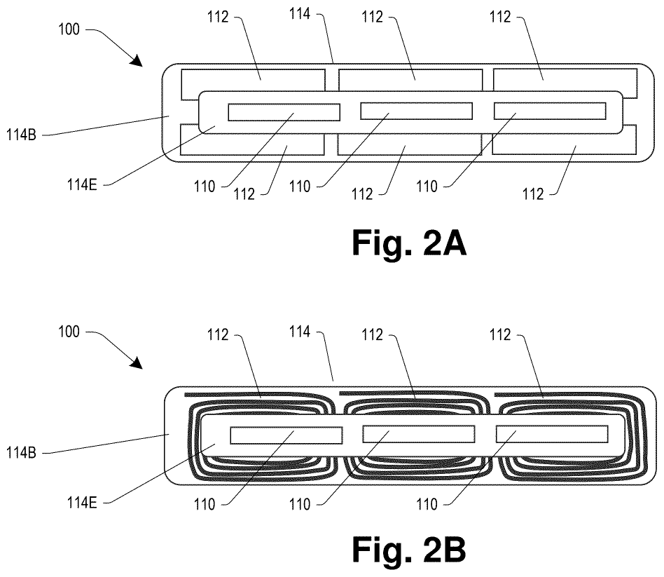

FIGS. 2A and 2B are top views of the control button 100, in accordance with some embodiments. In the embodiment of FIG. 2A, three touch sensors 110 are provided on the surface of the extending portion 114E of the body 114 and three capacitive force sensors 112, which may be segmented, are provided in the base portion 114. In the embodiment of FIG. 2B, three touch sensors 110 are provided on the surface of the extending portion 114E of the body 114 and three inductive force sensors 112 are provided in the base portion 114.

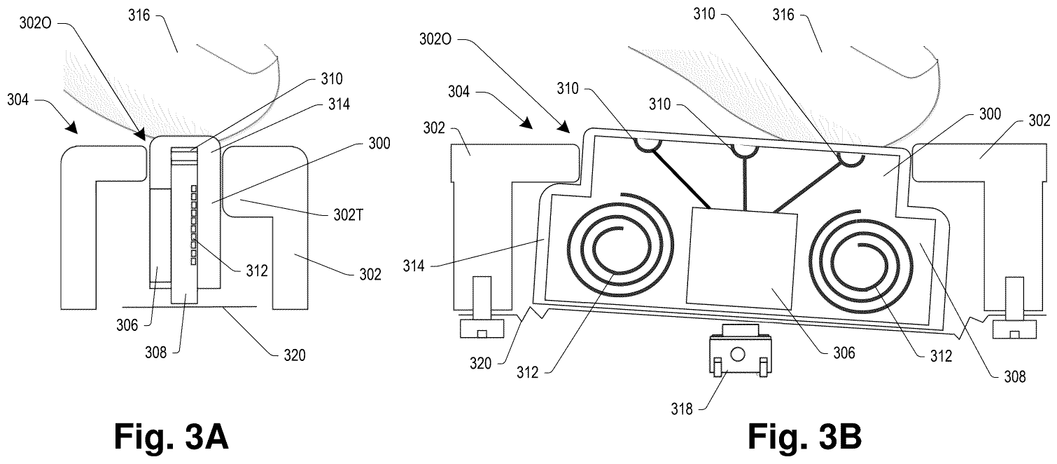

FIGS. 3A and 3B are diagrams of a control button 300 supported within a casing 302 of a device 304, in accordance with some embodiments. FIG. 3A illustrates a view along a width direction of the control button 300 and FIG. 3B illustrates a view along a length direction of the control button 300. In some embodiments, the control button 300 comprises a multi-sense controller 306 mounted to a printed circuit board 308 and connected to at least one touch sensor 310 and at least one force sensor 312. In the embodiment of FIG. 3, the printed circuit board 308 and multi-sense controller 106 are mounted vertically (e.g., perpendicular to the upper surface of the control button 100). A vertical orientation reduces the width of the control button 100, allowing a thinner form factor for the device 304. The touch sensors 110 may be exposed by an opening 302O in the casing 302. The number of touch sensors 310 and force sensors 312 may vary. In some embodiments, the control button 300 includes a body 314 that may comprise a molded material that encapsulates the multi-sense controller 306, the touch sensors 310, and the force sensors 312. In some embodiments, the touch sensors 310 comprise capacitive sensors that allow sensing of touch events from a user's finger 316 by the multi-sense controller 306, such as single taps, double taps, slides, or other touch events. In some embodiments, one or more mechanical switches 318 may be provided proximate the control button 300 to generate a digital displacement indication of the control button 300 being pressed downward. The output of the mechanical switch 318 may be registered by the device 304 rather than the multi-sense controller 306. In some embodiments, one or more springs 320, such as a leaf spring, a coil spring, a cantilevered spring, or some other type of spring is provided under the control button 300 to provide resistance to the force applied to the control button 300 by the user's finger 316.

Portions of the force sensors 312 may extend beneath the casing 302 and allow measure displacement relative to the casing 302. In some embodiments, the casing has an increased thickness portion 302T to facilitate a greater degree of overlap with the force sensors 312. In the embodiment of FIGS. 3A and 3B, the force sensors 312 are illustrated as inductive sensors, but capacitive sensors may be used. In the case of inductive sensors, the printed circuit board 308 may have multiple layers to increase sensitivity of the force sensors 312.

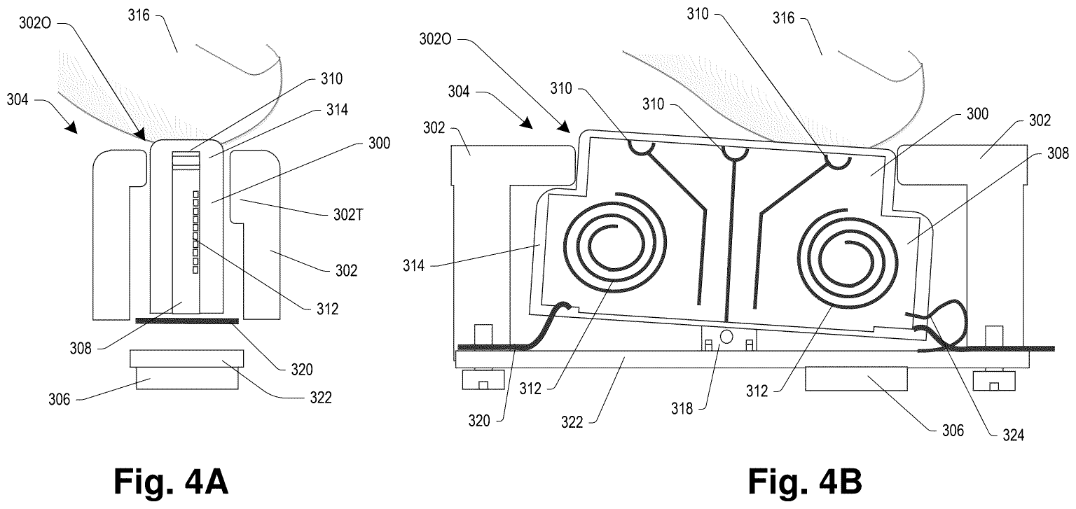

FIGS. 4A and 4B are diagrams of the control button 300, in accordance with some embodiments. Compared to the embodiment of FIGS. 3A and 3B, the multi-sense controller 306 is mounted to a second printed circuit board 322 separate from the body 314 and connected to the circuit board 308 to which the touch sensors 310 and the force sensors 312 are mounted by a flex cable 324.

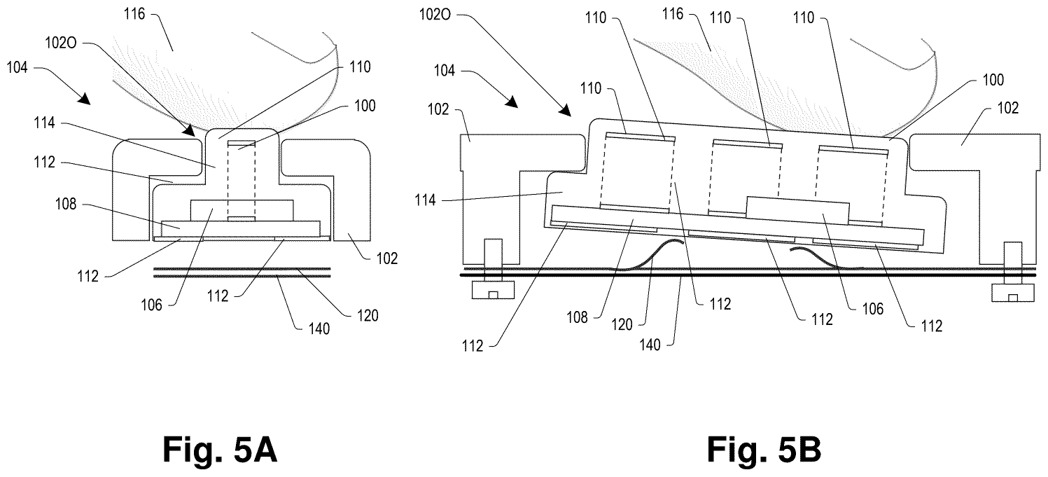

FIGS. 5A and 5B are diagrams of the control button 100, in accordance with some embodiments. Compared to the embodiment of FIGS. 1A and 1B, the multi-sense controller 106 is mounted to a top surface of the printed circuit board 108 and the force sensors 112 are present on the bottom side of the printed circuit board 108 proximate a support member 140. This arrangement may be used when the casing 102 is not conductive (e.g., plastic). The force sensors 112 measure displacement relative to the support member 140. The force sensors 112 may be capacitive or inductive sensors. However, in an embodiment where the support member 140 is not grounded and/or the control button 100 is used in an environment subject to moisture, water drops, etc. inductive force sensors may be used.

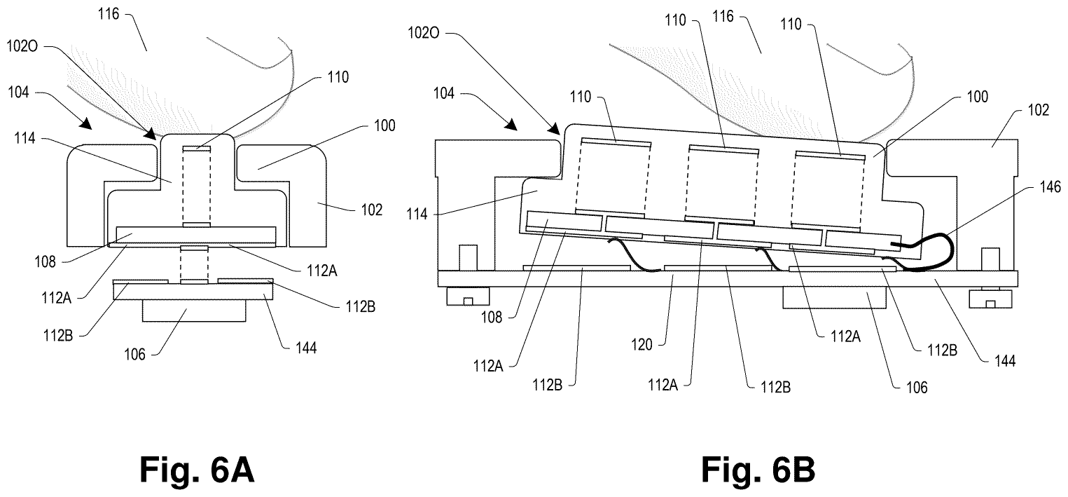

FIGS. 6A and 6B are diagrams of the control button 100, in accordance with some embodiments. Compared to the embodiment of FIGS. 1A and 1B, the multi-sense controller 106 is mounted to a second printed circuit board 144 and connected to the printed circuit board 108 to which the touch sensors 110 are connected and first members 112A of the force sensors 112 are mounted. Second members 112B of the force sensors 112 are mounted on the printed circuit board 144. A flex cable 146 connects the printed circuit board 108 to the printed circuit board 144. The force sensors 112 measure capacitance or inductance between the members 112A, 112B. In some embodiments, the printed circuit board 108 is omitted, the first members 112A are positioned near the bottom surface of the body 114, and the touch sensor 110 and first members 112A are connected to the multi-sense controller 106 by the flex cable 146.

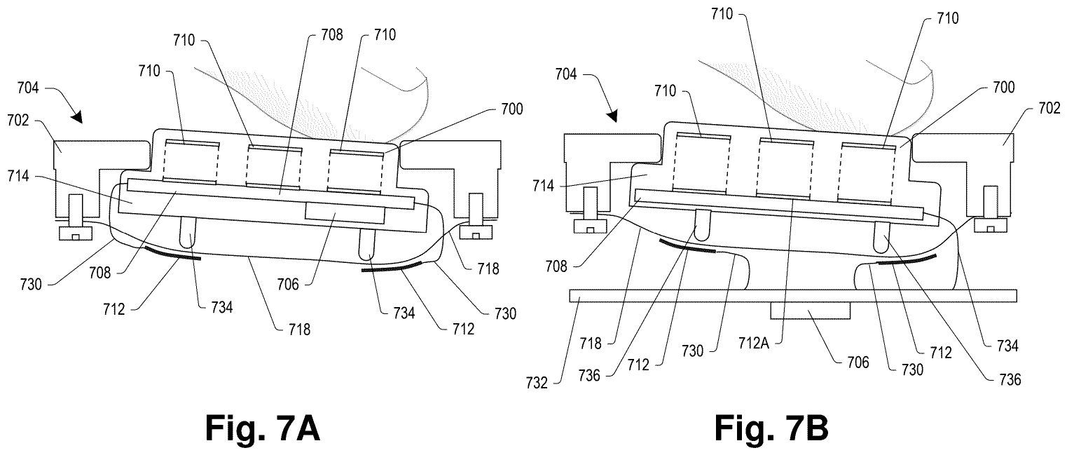

FIGS. 7A and 7B are diagrams of a control button 700 supported within a casing 702 of a device 704, in accordance with some embodiments. In some embodiments, the control button 700 comprises a multi-sense controller 706 connected to at least one touch sensor 710 and at least one force sensor 712. The force sensors 712 comprise strain gauges mounted to a spring 718, such as a leaf spring, and connected to the multi-sense controller 706 by flex cables 730. In the embodiment of FIG. 7A, the multi-sense controller 706 and the touch sensors 710 are connected to a printed circuit board 708 and encapsulated by a body 714 of the control button 700. In the embodiment of FIG. 7B, the touch sensors 710 are connected to the printed circuit board 708 and encapsulated by the body 714, the printed circuit board 708 is connected to a second printed circuit board 732 by a flex cable 734, and the flex cables 730 connect the force sensors 712 to the multi-sense controller 706 via the printed circuit board 732. In some embodiments, the control button 100 comprises stand-offs 736 that exert a force on the spring 718 when a corresponding force is applied to the top surface of the control button. The number of touch sensors 710 and force sensors 712 may vary.

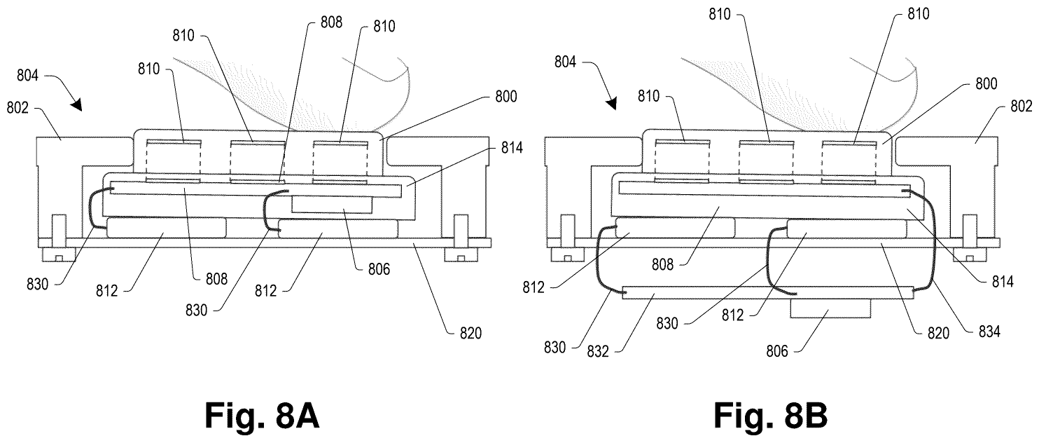

FIGS. 8A and 8B are diagrams of a control button 800 supported within a casing 802 of a device 804, in accordance with some embodiments. In some embodiments, the control button 800 comprises a multi-sense controller 806 connected to at least one touch sensor 810 and at least one force sensor 812. The force sensors 812 comprise piezoelectric film sensors provided on a support surface 820 and connected to the multi-sense controller 806 by flex cables 830. In the embodiment of FIG. 8A, the multi-sense controller 806 and the touch sensors 810 are connected to a printed circuit board 808 and encapsulated by a body 814 of the control button 800. In the embodiment of FIG. 8B, the touch sensors 810 are connected to the printed circuit board 808 and encapsulated by the body 814, the printed circuit board 808 is connected to a second printed circuit board 832 by a flex cable 834, and the flex cables 830 connect the force sensors 812 to the multi-sense controller 806 via the printed circuit board 832.

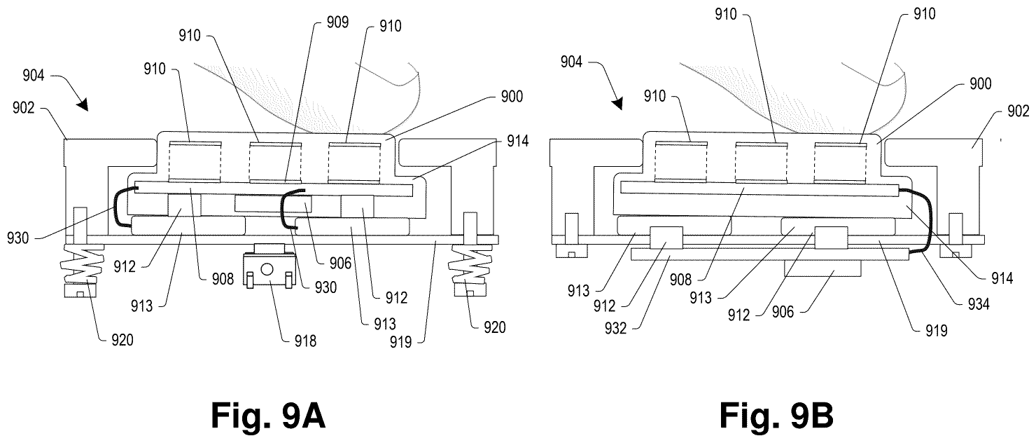

FIGS. 9A and 9B are diagrams of a control button 900 supported within a casing 902 of a device 904, in accordance with some embodiments. In some embodiments, the control button 900 comprises a multi-sense controller 906 connected to at least one touch sensor 910 and at least one force sensor 912. The force sensors 912 comprise capacitive micromachined ultrasonic transducers connected to gel pads 913 to facilitate pressure detection. The gel pads 913 are provided on a support surface 919 and connected to the multi-sense controller 906 by flex cables 930. In the embodiment of FIG. 9A, the multi-sense controller 906 and the touch sensors 910 are connected to a printed circuit board 908 and encapsulated by a body 914 of the control button 900. A mechanical switch 918 and springs 920 may contact the support surface 919. In the embodiment of FIG. 9B, the touch sensors 910 are connected to the printed circuit board 908 and encapsulated by the body 914, the printed circuit board 908 is connected to a second printed circuit board 932 by a flex cable 934, and the force sensors 812 connect to the to the multi-sense controller 906 via the printed circuit board 932.

The embodiments of FIGS. 1A, 1B, 2A, 2B, 3A, 3B, 4A, 4B, 5A, 5B, 6A, 6B, 7A, 7B, 8A, 8B, 9A, 9B may be combined in any way. For example, the descriptions of the touch event and force event processing apply to all of the embodiments. Elements such as mechanical switches, springs, and support surfaces may be provided with any embodiment, even if not illustrated herein. The use of sensor signals of different physical origin, such as capacitive, inductive, force, or other types, provides a sensor fusion approach that augments performance and improves the reliability of the system under harsh conditions.

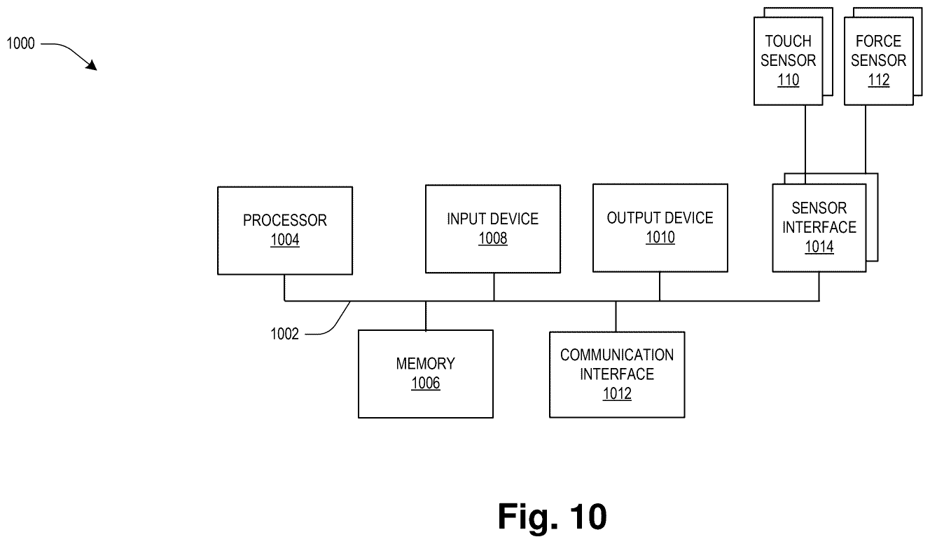

FIG. 10 is a diagram of a multi-sense controller 1000, in accordance with some embodiments. The multi-sense controller 1000 may implement one or more of the multi-sense controllers 106, 306 described herein. In some embodiments, the multi-sense controller 1000 comprises a bus 1002, a processor 1004, a memory 1006 that stores software instructions or operations, an input device 1008, an output device 1010, a communication interface 1012, and one or more sensor interfaces 1014. The touch sensors 110 or the force sensors 112 described herein may interface with the multi-sense controller 1000 via the at least one sensor interface 1014. The sensor interface 1014 may include multiple channels where multiple sensors 110, 112 can be connected and processed in parallel or one or more channels may be shared by multiple sensors 110, 112 and processed sequentially using time interleaving. The sensor interface 1014 may be an analog interface that may be programmable or configurable to support different types of sensors 110, 112 and may include analog circuitry, such as amplifiers, comparators, analog-to-digital converters, or other circuits that convert analog inputs to digital outputs for processing by the processor 1004. The multi-sense controller 1000 may include fewer components, additional components, different components, and/or a different arrangement of components than those illustrated in FIG. 10.

According to some embodiments, the bus 1002 includes a path that permits communication among the components of the multi-sense controller 1000. For example, the bus 1002 may include a system bus, an address bus, a data bus, and/or a control bus. The bus 1002 may also include bus drivers, bus arbiters, bus interfaces, clocks, and so forth. The processor 1004 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processor 1004 may be implemented as hardware (e.g., a microprocessor, etc.), a combination of hardware and software (e.g., a SoC, an ASIC, etc.), may include one or multiple memories (e.g., cache, etc.), etc.

The processor 1004 performs one or multiple operations based on an operating system and/or various applications or computer programs (e.g., software). The processor 1004 accesses instructions from the memory 1006, from other components of the multi-sense controller 1000, and/or from a source external to the multi-sense controller 1000 (e.g., a network, another device, etc.). The processor 1004 may perform an operation and/or a process based on various techniques including, for example, multithreading, parallel processing, pipelining, interleaving, etc.

In some embodiments, the memory 1006 includes one or multiple memories and/or one or multiple other types of storage mediums. For example, the memory 1006 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other suitable type of memory. The memory 1006 may include a hard disk, a magnetic disk, an optical disk, a magneto-optic disk, a solid state disk, a Micro-Electromechanical System (MEMS)-based storage medium, a nanotechnology-based storage medium, and/or some other suitable disk. The memory 1006 may include drives for reading from and writing to the storage medium. The memory 1006 may be external to and/or removable from the multi-sense controller 1000, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). The memory 1006 may store data, software, and/or instructions related to the operation of the control button 100.

The communication interface 1012 permits the multi-sense controller 1000 to communicate with other devices, networks, systems, sensors, and/or the like on a network. The communication interface 1012 may include one or multiple wireless interfaces and/or wired interfaces. For example, the communication interface 1012 may include one or multiple transmitters and receivers, or transceivers. The communication interface 1012 may operate according to a protocol stack and a communication standard. In some embodiments, the communication interface 1012 includes an antenna. The communication interface 1012 may include various processing logic or circuitry (e.g., multiplexing/de-multiplexing, filtering, amplifying, converting, error correction, etc.). In some embodiments, the communication interface 1012 operates using one or more of a long range wireless protocol, a short range wireless protocol, or a wired protocol.

In some embodiments, the input device 1008 permits an input into the multi-sense controller 1000. For example, the input device 1008 may comprise a keyboard, a mouse, a display, a touchscreen, a touchless screen, a button, a switch, an input port, speech recognition logic, and/or some other type of suitable visual, auditory, or tactile input component. The touch sensor array 202 may be incorporated into the input device 1008. The output device 1010 permits an output from the multi-sense controller 1000. For example, the output device 1010 may include a speaker, a display, a touchscreen, a touchless screen, a projected display, a light, an output port, and/or some other type of suitable visual, auditory, or tactile output component.

In an embodiment of the techniques presented herein, a control button comprises a body, a touch sensor proximate a first surface of the body, a force sensor, and a multi-sense controller connected to the touch sensor and the force sensor and configured to identify a touch event based on an analog response of the touch sensor and identify a force event based on an analog response of the force sensor.

In an embodiment of the techniques presented herein, the control button comprises a printed circuit board, wherein the multi-sense controller is mounted to the printed circuit board, the multi-sense controller is connected to the touch sensor by the printed circuit board, and the multi-sense controller is connected to the force sensor by the printed circuit board.

In an embodiment of the techniques presented herein, the printed circuit board is perpendicular to the first surface.

In an embodiment of the techniques presented herein, the body encapsulates the touch sensor, the force sensor, the printed circuit board, and the multi-sense controller.

In an embodiment of the techniques presented herein, the control button comprises a first printed circuit board and a second printed circuit board connected to the first printed circuit board, wherein the touch sensor is connected to the first printed circuit board, the force sensor is connected to the first printed circuit board, and the multi-sense controller is mounted to the second printed circuit board.

In an embodiment of the techniques presented herein, the control button comprises a first printed circuit board and a second printed circuit board connected to the first printed circuit board, wherein the touch sensor is connected to the first printed circuit board, the force sensor is connected to the second printed circuit board, and the multi-sense controller is mounted to the second printed circuit board.

In an embodiment of the techniques presented herein, the control button comprises a support member, wherein the analog response of the force sensor is a function of displacement relative to the support member.

In an embodiment of the techniques presented herein, the analog response of the force sensor is a function of displacement relative to a casing of a device with which the control button is associated.

In an embodiment of the techniques presented herein, the body comprises a base portion supporting the touch sensor and an extending portion extending from the base portion and supporting the force sensor.

In an embodiment of the techniques presented herein, the force sensor comprises at least one of a capacitive sensor, an inductive sensor, a strain gauge, a piezoelectric film sensor, or a capacitive micromachined ultrasonic transducer.

In an embodiment of the techniques presented herein, the control button comprises a mechanical switch configured to generate a digital signal indicating displacement of the body.

In an embodiment of the techniques presented herein, a multi-sense controller comprises a sensor interface and a processor configured to receive analog touch data over the sensor interface, identify a touch event based on the touch data, receive analog force data over the sensor interface, identify a force event based on the force data, and communicate the touch event and the force event to a device.

In an embodiment of the techniques presented herein, the analog touch data comprises capacitance data.

In an embodiment of the techniques presented herein, the analog force data comprises displacement data indicative of displacement associated with a control button.

In an embodiment of the techniques presented herein, the touch event comprises at least one of a touch or a slide.

In an embodiment of the techniques presented herein, the force event comprises at least one of a click of a control button or a tilt of the control button.

In an embodiment of the techniques presented herein, a method comprises receiving analog touch data over a sensor interface, identifying a touch event based on the touch data, receiving analog force data over the sensor interface, identifying a force event based on the force data, and communicating the touch event and the force event to a device.

In an embodiment of the techniques presented herein, receiving the analog touch data comprises receiving capacitance data.

In an embodiment of the techniques presented herein, receiving the analog force data comprises receiving at least one of capacitance data, inductance data, force data, or displacement data.

In an embodiment of the techniques presented herein, receiving the analog force data comprises receiving displacement data indicative of displacement associated with a control button relative to a casing of the device.

The term “computer readable media”may include communication media. Communication media typically embodies computer readable instructions or other data in a “modulated data signal” such as a carrier wafer or other transport mechanism and includes any information delivery media. The term “modulated data signal” may include a signal that has one or more of its characteristics set or changed in such a manner as to encode information in the signal.

Any aspect or design described herein as an “example” and/or the like is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A control button, comprising:
a body;
a touch sensor proximate a first surface of the body;
a force sensor; and
a multi-sense controller connected to the touch sensor and the force sensor and configured to:
identify a touch event based on an analog response of the touch sensor; and
identify a force event based on an analog response of the force sensor.

2. The control button of claim 1, comprising:
a printed circuit board, wherein:
the multi-sense controller is mounted to the printed circuit board;
the multi-sense controller is connected to the touch sensor by the printed circuit board; and
the multi-sense controller is connected to the force sensor by the printed circuit board.

3. The control button of claim 2, wherein:
the printed circuit board is perpendicular to the first surface.

4. The control button of claim 2, wherein:
the body encapsulates the touch sensor, the force sensor, the printed circuit board, and the multi-sense controller.

5. The control button of claim 1, comprising:
a first printed circuit board; and
a second printed circuit board connected to the first printed circuit board, wherein:
the touch sensor is connected to the first printed circuit board;
the force sensor is connected to the first printed circuit board; and
the multi-sense controller is mounted to the second printed circuit board.

6. The control button of claim 1, comprising:
a first printed circuit board; and
a second printed circuit board connected to the first printed circuit board, wherein:
the touch sensor is connected to the first printed circuit board;
the force sensor is connected to the second printed circuit board; and
the multi-sense controller is mounted to the second printed circuit board.

7. The control button of claim 1, comprising:
a support member, wherein the analog response of the force sensor is a function of displacement relative to the support member.

8. The control button of claim 1, wherein:
the analog response of the force sensor is a function of displacement relative to a casing of a device with which the control button is associated.

9. The control button of claim 1, wherein:
the body comprises:
a base portion supporting the touch sensor; and
an extending portion extending from the base portion and supporting the force sensor.

10. The control button of claim 1, wherein:
the force sensor comprises at least one of a capacitive sensor, an inductive sensor, a strain gauge, a piezoelectric film sensor, or a capacitive micromachined ultrasonic transducer.

11. The control button of claim 1, comprising:
a mechanical switch configured to generate a digital signal indicating displacement of the body.

12. A multi-sense controller, comprising:
a sensor interface; and
a processor configured to:
receive analog touch data over the sensor interface;
identify a touch event based on the touch data;
receive analog force data over the sensor interface;
identify a force event based on the force data; and
communicate the touch event and the force event to a device.

13. The multi-sense controller of claim 12, wherein:
the analog touch data comprises capacitance data.

14. The multi-sense controller of claim 12, wherein:
the analog force data comprises displacement data indicative of displacement associated with a control button.

15. The multi-sense controller of claim 12, wherein:
the touch event comprises at least one of a touch or a slide.

16. The multi-sense controller of claim 12, wherein:
the force event comprises at least one of a click of a control button or a tilt of the control button.

17. A method, comprising:
receiving analog touch data over a sensor interface;
identifying a touch event based on the touch data;
receiving analog force data over the sensor interface;
identifying a force event based on the force data; and
communicating the touch event and the force event to a device.

18. The method of claim 17, wherein:
receiving the analog touch data comprises receiving capacitance data.

19. The method of claim 17, wherein:
receiving the analog force data comprises receiving at least one of capacitance data, inductance data, force data, or displacement data.

20. The method of claim 17, wherein:
receiving the analog force data comprises receiving displacement data indicative of displacement associated with a control button relative to a casing of the device.
